(19) United States
(12) Patent Application Publication
(10) Pub. No.: US 2024/0298673 A1
(43) Pub. Date: Sep. 12, 2024

(54) DOG SACHET

(71) Applicants: Nico ENCHELMAIER, Rheinfelden (CH); Lisa DOBUSCH, Rheinfelden (CH); Volker ENCHELMAIER, Rheinfelden (CH)

(72) Inventors: Nico ENCHELMAIER, Rheinfelden (CH); Lisa DOBUSCH, Rheinfelden (CH); Volker ENCHELMAIER, Rheinfelden (CH)

(73) Assignee: LOUIDS AG, Niederrohrdorf (CH)

(21) Appl. No.: 18/550,377

(22) PCT Filed: Mar. 18, 2022
(86) PCT No.: PCT/EP2022/057211

§ 371 Date: Sep. 13, 2023

(30) Foreign Application Priority Data
Mar. 18, 2021 (CH) 00293/21

(51) Int. Cl. A23K 40/30; A01K 7/00; A23K 20/163; A23K 50/48

(52) U.S. Cl. CPC A23K 40/30; A01K 7/00; A23K 20/163; A23K 50/48

(57) ABSTRACT

The invention relates to a sachet (1) for a mobile supply of liquid for dogs in particular. The sachet comprises a casing (2) and a core medium (3) which is surrounded by the casing. The casing (2) is made of an edible membrane, and the core medium (3) is made of a gelled liquid substance.

### TECHNICAL FIELD

The invention relates to an edible sachet for mobile liquid supply, in particular for dogs, in accordance with the introductory part of independent claim 1.

### BACKGROUND

Often, the liquid supply of dogs on the road or in the mobile interfaces of a dog owner's everyday life, i.e., in particular during walks and on trips (vacation trips or day trips, including car trips) as well as other interfaces for the requirement of liquid intake (restaurant visits, city tours, sports activities with the dog owner such as jogging, bicycle tours or hikes, etc. can not be ensured to a sufficient extent), cannot be guaranteed to a sufficient extent, because no appropriate water sources or watering troughs are available and/or the dog owner is not aware of the problem of a possible undersupply.

During walks, dogs are exposed to a high physical, dehydrating load due to the increased activity and stress on the musculoskeletal system in combination with other general conditions, such as changing climatic environmental conditions. In addition, there are other associated stress demands such as the action area of car trips possibly associated with the walk, which also bring liquid-depriving effects for the dog's organism.

Against this background, a mobile liquid supply is to be integrated beside the stationary (main) supply (i.e. in particular the domestic water and/or drinking bowl) indispensably supplementary into the everyday life of the dog. Being out with the dog without a source of liquid supply can lead to significant dehydrating effects and consequently to a worsened well-being (physical and mental sluggishness, fatigue), a lower vitality (physiological and energetic) and also to a circulatory symptomatology.

Very often in the everyday life of dog and dog owner (role of need recognition and fulfillment), the food receptacle is unconsciously more in focus than an equally more important regular, constant and sufficient mobile and stationary liquid supply and receptacle. This finding is due to a lack of education regarding the importance of a mobile, but also a general, regular and controlled liquid supply, and on the other hand, to a lack of a holistic mobile product solution in relation to a correlating composition of dog, dog owner and environmental and mobile environment conditions. There is a close, synergistic relationship between mobile and stationary liquid supply to a dog. This involves the reciprocal cycle of stationary liquid supply (main supply source), which supports the mobile liquid supply with a preceding, basic hydration, and mobile liquid supply (situational supplementary source), which serves both the mobile-hydration quenching of an acute feeling of thirst and also supplements the stationary liquid supply, in the sense of achieving the daily quantity requirement.

In addition, the aspect of the lack of liquid supply is favored by the sharply increasing number of people who get a dog for the first time and take the position of the dog owner or by their inexperience. The mobile liquid supply of dogs on the basis of the currently available methods for a corresponding coverage of needs, takes place approximately with regard to the mobile interfaces mainly in conventional solution form, i.e. in the form of filled drinking bottles and/or portable dog (travel) bowls, and in isolated use cases on the basis of market-related mobile transport containers, such as travel drinking bottles and other combination systems.

For example, DE 20 2004 012 452 U1 describes a drinking bowl for the receptacle and securing of water, which allows animals to drink without spilling in turbulent conditions. Two drinking bowls are placed one above the other, wherein the upper drinking bowl must have a shortened water base in connection with side slopes and through this opening the animal can reach the water in the base of the lower drinking bowl with its tongue.

Further, U.S. Pat. No. 10,028,484 B2 discloses a portable travel cup and water bowl combination that is used to store water and dispense water such that a dog can drink it, and which subsequently allows the unused water to be returned to the travel cup. To this end, the water bottle comprises a top portion, a bottom portion, and an interior recessed portion that allows the bottle to be squeezed to force water from the bottle into the dog bowl through a straw while providing sufficient rigidity to ensure that the bottle is not permanently deformed by the squeezing. The water bottle is further designed to fit and be stored in a standard car beverage container.

Such mobile transport containers, which are developed and offered in the sense of a combination system of transport bottle, drinking bowl and additional liquid to be filled, are not able to solve the criterion of an easily applicable, rewarding and holistically developed depth of need of a mobile liquid supply of dogs. Although these are basically more functional and mobile designs, the core problem still remains. The dog must be accustomed to a new drinking vessel and with this solution form it comes possibly to the fact that a substantial portion of water splashes, or the dog swallows itself as also with the domestic, stationary drinking bowl and this is lost thus, as well as that the remaining water/liquid must be emptied away unused after the walk and the dog remains again unprovided in the mobile interface. Thus, currently accessible mobile liquid intake is perceived by the dog with a limited reward association due to a small differentiation distance and no need-based novelty imprinting.

In addition, particularly when the dog feels very thirsty, it can splash more water/liquid than it can effectively absorb via the drinking technique of the spoon-shaped tongue muscle, with the result that swallowing often occurs during liquid intake from such mobile transport vessels, also due to the not optimally controllable aggregate state “liquid (fluid) or too flowable/viscous (soft-viscous to viscous)” and the non-existent pre-portioning of a determined quantity ratio. Finally, the effort for the dog owner in the course of preparation, transport and application on location as well as hygienic treating of the vessel after use turns out to be very high, (user-) unfriendly and complex (time-consuming). It can thus be stated that today's mobile solutions are not at all as mobile and solution-oriented as they seem at first glance.

This aspect is not in a balanced relationship to the ever-increasing, emancipation-related, dynamic everyday life of a large number of dog owners, as well as an increasing urbanization (city rush), in which in the course of walks with dogs the concept of “mobility” is to be classified as indispensable. To date, none of the existing product solutions for the mobile liquid supply of dogs has integrated into the daily lives of owners and dogs in such a way that it could be described as covering all areas of need for dogs and dog owners in the sense of positioning a basic need product.

As a result, dogs are left with inadequately rewarding, refreshing, thirst-quenching, hydrating, and flavorful and nutrient- and mineral-rich mobile hydration, in the sense of meeting a basic need, in the mobile interfaces of their daily lives.

The interfaces for a necessary liquid intake of the dog are particularly in the daily periods before going to bed as well as after getting up due to a risk of dehydration at night, and before (preventive), during and after the morning, midday and evening walk. Further to mention are activity and stress of the musculoskeletal system in connection with the climatic environmental conditions, outward and return journey or long car journeys as well as vacation trips or day trips, with which it comes sometimes to longer journeys and thus to increased physical, dehydrating stresses for the organism of the dog. An interface also occurs during and after feeding (depending on the type and composition of the main feed, if any, and the frequency of feeding) to compensate for the amount of fluid lost and stressed in the organism during digestion.

The seasonal volatility of liquid intake cycles, particularly on days with hot climatic environments, regular, adequate, and location- and time-independent liquid intake is essential. Also, to be considered are dogs that are subjected to a consistently high level of physical stress and have a consistently mobile characterized daily routine, as is the case, among other things, with dogs used for work and service. Fluid deprivation due to illness, such as diarrheal illness, fever, vomiting, kidney disease, or diabetes mellitus, should also be considered. Regular drinking throughout the day is necessary, both stationary and especially mobile, to achieve the daily minimum requirement of the amount of liquid intake, in full knowledge agreement with the dog owner. In fact, holistic hydration of the dog has a positive effect on both its physiological and energetic state.

In the context of the need recognition, -discussion and -solution it became conscious that humans make the time and place-independent satisfaction of the basic need level of the so-called “Maslow pyramid” as an automated matter of course and the dog owners coming out of it, even if unconsciously or ignorantly, withhold this fulfillment characteristic from the dog due to missing, lasting clearing-up and/or missing total solutions. In particular, the dog owner lacks knowledge regarding the actual daily mobile and stationary amount of fluid ingested by their dog.

The object of the present invention is therefore to provide a solution for the mobile liquid supply of dogs which can be used more flexibly, is easier to handle, is easier to transport, is more rewarding, is tailored to the needs of the dog and dog owner as a whole, is more informative, can be integrated and can be portioned or controlled according to need than is the case with known solutions.

### BRIEF SUMMARY

According to the invention, the object is solved by an edible sachet for a mobile liquid supply of dogs in particular, as defined in independent claim 1. Advantageous embodiments of the invention follow from the dependent claims.

The essence of the invention consists of the following: A sachet for a mobile liquid supply of dogs in particular. The sachet comprises a casing and a core medium enclosed by the casing. In this case, the casing is formed from a edible membrane and the core medium is formed from a gelled liquid substance.

The term “gelled liquid substance” comprises the textural behavior of non-flowable (i.e. without temperature-related intervention no rheological properties in the sense of fluidity or viscosity), (firmly) cohesive, sometimes cuttable or cut-resistant, as well as (soft) gel solids (hydrocolloid) provided with an individual molecular network depending on the gelling agent used. The molecular chains that build up during the gelling process have a high water- or liquid-binding activity and, during the so-called phase transition from “sol (two-phase system between liquid and added gelling agent form)” to the gel phase “solid (single-phase, colloidal system from individual gel solidification point)”, give rise to an aggregate state that contains water or liquid but is nevertheless solid, slightly to non-mobile and suitable for chewing and consumption. The exception to this is, for example, homogeneously prepared “fluid gels”, which can have a divergent consistency of a pasty-viscous and thus viscous gel, or (highly) viscous or pasty-viscous or viscous-elastic or viscous-solidly bound, thickened and/or flowable-gelled liquid substances, as defined in dependent claim 15. The gelled liquid substance also has particularly gastrointestinal liquid-releasing properties, as well as supplements, if any, located in the liquid substance for additional functional absorption and absorption.

In the present case, the term “sachet” expressly refers to the entire product, i.e. the casing and the core medium.

The term “edible” in the present case refers to the fact that particularly dogs can eat the sachet completely or digest it (non-)enzymatically, i.e. without any adverse health effects. In principle, the sachet can also be used for other domestic or (pet) animal species, such as cats in particular. However, the primary use is directed at dogs.

The edible membrane contains with advantage the functional characteristic insoluble in water. The term “water-insoluble” refers in particular to the fact that the membrane does not dissolve or become leaky on contact with water, liquids or (moist) gels (e.g. due to the effects of rain during walks), so that the moist core contents can also be enclosed therein without impairment and thus approximately also a homogeneous adaptation of the gelled content mass to the inside of the membrane shell can be generated in the thermal (post-treatment) process of a so-called post-gelation, i.e. a renewed liquefaction (thermoreversibility) by a heating step individually adapted to the gelling agent and subsequently repeated reaching of the gel solidification point.

At the same time, the membrane should also preferably be resistant to heat or temperature, such as cooking, baking, refrigeration and freezing, to such an extent that it remains intact both at high summer temperatures and at cold winter temperatures (application load in mobile interface), as well as with regard to process loads. In addition, it is also desirable for the membrane to be biodegradable (i.e., as in the case of a polysaccharide- or protein-based biopolymer, approximately).

Furthermore, the term “membrane” comprises thin layers of material or fabric (such as a film, a skin, a film or a gel) which have a large surface area in relation to their thickness and which separate two rooms from each other (i.e. here the interior of the sachet with the core medium from the external atmospheric environment). The membrane encloses the core medium in a sealing manner so that no substantial loss of contents occurs, which fact can be additionally ensured by the aggregate state of an enclosed (soft) gel solid.

The gelled liquid substance, even in low concentration spheres in connection with a low water-binding and water-retaining power or gel strength, is advantageously enclosed by the membrane in a plastically taut and stably cohesive manner and brought into a homogeneous, consistent form that is firm to the dog's bite and suitable for the corresponding chewing load in terms of fracture mechanics.

Preferably, the edible membrane comprises a polymer, more preferably an alginate. In principle, however, all other edible membrane materials can be considered, which are based on vegetable (e.g. biopolymers (polysaccharides or proteins) in the sense of e.g. vegetable artificial casings), animal (e.g. animal proteins or polysaccharides or natural casings), synthetic or other food-related edible and approved sources of origin and raw materials, sometimes based on gelling agents, individually used or synergistic mixtures of stabilizers (e.g. gelling agent-gelling agent, gelling agent-binder/thickener/starch, optionally also in connection with stabilizing additives). The membrane can also be formed by means of appropriate films, foils, gels or skins.

Due to the proportionally constant taut, robust and stable texture of the polymer or alginate membrane, which is elastic in its original characteristics, on edible, gelled liquids, the dog is provided with a bite-resistant medium that is optimally adapted to the purpose of mobile liquid supply in terms of receptacle, control, chewing and eating ability. In addition, the membrane ensures a protective function, limited in time depending on the level of impairment of the diffusion openness, with regard to possible drying out of the filled contents or of the liquid bound in the gel network, which aspect is fulfilled particularly effectively by the inclusion of a hydrocolloid, with a particular focus on that of a heat-stable stabilizer such as the biopolymer agar-agar in the form of a high temperature ramp of the gel melting point from/above approximately 85° C.

Alginate-based membranes, for example, have the property of diffusion openness, i.e. if oxygen and other influencing environmental factors were to impact the membrane, this would also have a direct effect on the contents enclosed within it as well as the general texture behavior. If necessary, this would result in membrane slackness and a reduction in the content substance. This aspect is particularly important if the contents are in a liquid or flowable state and thus in an aggregate state that can diffuse to the outside via the (alginate) shell. As a result of the fact that a casing or encapsulation of a gelled liquid is selected as the core medium, the membrane remains relatively taut despite its openness to diffusion due to the physical stability of the core medium when exposed to active oxygen and temperature (e.g. outside the outer packaging) and there is only a slight reduction in the contents than if these were liquid or viscous, with regard to limited water or liquid storage in the molecular network (i.e. due to the physical stability of the core medium). Also, the aggregate state “gelled” is a central process parameter for a thermal post-treatment in connection with the manufacturing process for generating a microbiological and physico-chemical as well as sensory product stability in view of the (high) temperature barrier for achieving thermoreversibility in the sense of a continuous liquefaction, such as in the case of agar-agar in particular, without, as in the case of fluid to viscous liquids, a significant loss of volume and also without a shelf-life-binding pH value reduction, a differentiating factor. Further, if fluid to viscous liquid substances were included, the elasticity prevalent in the basic texture of most membrane forms could not be converted into a bite-proof body filling of the “sachet”, and would consequently be perceived by the dog as too floppy, elastic and mobile.

Due to the gelled core medium and the robustness and resistance intended, among other things, the sachet according to the invention becomes process-stable in view of its physical stability with regard to the production, shelf-life, logistical and application-related method steps.

The membrane holds together the filled, preferably soft-brittle, gelled liquid substance with a high proportion of bound liquid (hydrocolloid) and thus implies a significant contribution to the texture result of the sachets. This enables the dog owner to administer the sachet without prior disintegration of the core medium into individual gel fragments, which is sometimes hygienic due to the preferred moist-gelled surface coating of the hydrocolloid. The membrane also allows the dog optimal preoral receptacle of the sachets without loss of content due to the sharp-tipped tooth structure (i.e., particularly through the incisors).

Finally, the membrane allows for a pre-dosed (precise volume dosing) and dog-controllable volume of gelled fluid substance to be added. The texture of the membrane shell, given the surface texture, is preferably such that it can result in a low-friction consumption and swallowing process by the dog.

In the case of an alginate membrane, a substance agonist in the form of calcium chloride or calcium lactate (alginate gels with calcium ions to form membrane networks (encapsulation)) is added to the alginate as a crosslinking solution in the course of membrane construction. This can achieve a particularly effective form of networking.

Preferably, the alginate membrane is based on an alginate paste in dependent connection with the machine application process, which contains a determined amount of sodium alginate in the product composition. Sodium alginate refers to the sodium salt of alginic acid and is obtained from the resource of brown algae (a form of seaweed). Such an alginate paste also combines a predominantly high proportion of bound water, which, in relation to the percentage of the casing product of any sachet volume, can be released gastrointestinally to a certain extent by the canine organism, i.e. in addition to the gelled liquid core, and then resorbed and absorbed.

Sodium alginate is generally classified as fermentable vegetable fiber (dietary fiber) and has no adverse health-related effects in dogs in particular. The alginate as a starting product can in principle also be present in an aggregate state other than pasty. The use of alternative membrane materials with comparable properties is conceivable.

Preferably, the edible membrane has a thickness of from approximately 0.05 mm to approximately 5 mm, preferably from approximately 0.1 mm to approximately 2 mm, more preferably from approximately 0.15 mm to approximately 1.5 mm, and more preferably from approximately 0.2 mm to approximately 1 mm. Thicknesses smaller than 0.05 mm can lead to unwanted bursting or tearing of the membrane, and thicknesses greater than 5 mm are less likely to be accepted by dogs. The membrane can be a single, double or multilayer casing.

Preferably, the gelled liquid substance comprises soups, broths or smoothies, as well as other content variants of functional foods (functional foods) on an animal or vegetable or vegetarian or vegan basis that are liquid to viscous in the original aggregate state, or drinking water, or supplements added to the liquid substance. Supplements in the present context refer to such additives or raw materials, irrespective of their form, which in combination with water or liquid have as their subject matter the liquid intake of dogs in particular. This also comprises supplements which have a naturopathic or homeopathic, vitalizing or nutrient-rich, drink-absorbing, health-, hygiene- or care-promoting effect for dogs and which are released gastrointestinally in connection with the liquid contained in the gel and are available for nutritional or purpose-oriented utilization (dissolution). Hydrogels in the sense of a water-carbohydrate polymer composite as energy suppliers, as well as oils, yogurt drinks, shakes, juices, teas or alternative liquid forms with comparable properties are equally applicable. Accordingly, both two-phase components in the sense of liquid and gelling agent and three-phase components in the sense of liquid plus functional substance (e.g. of a homeopathic nature) and gelling agent are centralized.

Preferably, the gelled liquid substance is gelled by means of gelling agents such as in particular agar-agar, gelatin, alginate(s), alginic acid, carrageenan, pectin or tragacanth. In principle, all other gelling agents approved for use on dogs (or gelling agents approved for use on feed and feed supplements) can also be used. Conceivable with regard to the use of particularly synergetic substance ratios (i.e. gelling agent (base) in composition with binding and/or thickening agent, starch, emulsifiers, as well as gelling agents which can also be used as binding and thickening agents (additive)), the use of starch is also possible, binding and/or thickening agents such as approximately locust bean gum, guar gum, arrowroot gum, psyllium husks, corn starch, potato starch, xanthan gum, gum arabic, tara gum, gellan gum, cellulose or caseins, as well as of all other ingredients permitted for use on the dog (resp. on feed and feed supplements approved) starches, binders and thickeners and emulsifiers.

These may be individual substances of the gelling agent groups or synergistic fabrics in the form of a fabric structure of gelling agent-gelling agent or gelling agent-thickener/binder/starch, which are based on vegetable, animal or synthetic or other food-related edible and approved sources of origin and raw materials. With regard to the design of the sachet according to the invention for the mobile liquid supply of dogs, the vegetable fiber (dietary fiber) agar-agar is particularly preferred as the gelling agent stabilizing the hydrocolloid or the (soft) gel solid. Furthermore, binders, thickeners or starches can also be used individually or also in a synergistic material structure, i.e. binder-binder, thickener-thickener, starch-starch, binder-thickener, binder-starch, thickener-starch.

Agar-agar is obtained from the outer cell walls of the red alga and defines a fermentable, vegetable fiber (dietary fiber) from the colloid group of biodegradable polysaccharides (biopolymer), which cannot be (largely) enzymatically digested and metabolized by the canine organism. Due to the fiber property, the fiber does not penetrate directly into the metabolic and digestive circulation of the dog organism, leaving the (mobile) liquid intake and supply in the center of the positioned product function. Agar-agar, unlike other vegetable hydrocolloid-forming gelling agents, has no enzymatic or chemical (gastric juice; digestive enzymes) digestive effects for gastrointestinal release of the liquid bound in the gel solids. This is mainly due to the pH insensitivity as well as acid resistance of agar gels. With this in mind, the release effectiveness is based on a low concentrated agar weight (wt. %, i.e. related to “gelled liquid substance (core medium)” independent of membrane) of the agar gel retained and -formed in the membrane, in connection with the oral processing or oral masticatory mechanics of the dog (gel break-up), and in particular the mechanical digestive or shear forces in the form of peristalsis, in order to be able to expose the liquid (lightly) bound in the network under further continuous gel break-up, without recurrent water-binding swelling in the intestinal passage. Agarose gels possess the functional property of water or liquid exudability under mechanical stress such as that of peristalsis of the digestive system. Furthermore, different digestion and liquid release mechanisms based on differently behaving gelling agents, such as gelatin (melting of gelatin gel fragments in the mouth; enzymatic digestion and degradation of gelatin chains) or pectin (chemical but not enzymatic digestion in the sense of pH-sensitive network degradation in the stomach, with subsequent renewed swelling and water binding activity in the intestinal tract), may also be conceivable.

The fiber material possesses the functional property of a high temperature ramp concerning the thermoreversibility of the gelled core medium, i.e. melting and liquefaction, only from a temperature range above approximately 85° C. The gelled core medium is then able to melt and liquefy. Compared to this, the gel solidification point occurs from below approximately 40° C. This ensures an optimum starting position for the criterion of maintaining physical (long-term) stability.

In addition, core media generated from agar-agar can be used in all temperature zones related to everyday life, which above all ensures agile-flexible use, with consistent texture behavior of the sachets in the mobile interfaces mentioned, taking into account the (climatic) environmental conditions.

The gel strength in the sense of the degree to which the helices are screwed together to form aggregates (network) using agar-agar depends in particular on the concentration, the heating temperature and time and the pH value of the added liquid substance to be converted into a gel solid. Therefore, the concentration of agar-agar must be adapted to the liquid substance present in each case, depending on its pH property, since the risk of long-term physical decomposition of the hydrocolloid can occur with decreasing pH. Preferred concentration ranges (agar weight; wt %) for, for example, agar-agar are between 0.4 wt % and 1.5 wt % for the indicated liquid substances, preferably between 0.6 wt % and 1.2 wt % and particularly preferably approximately 0.7 wt % to 1.1 wt %. The gel concentration must be set individually for each other gelling agent used, with reference to the code number associated with the gelling agent.

Agar-agar, like the alginate shell, goes back to the basic resource of marine algae (outer cell walls of the red algae) and represents a blend of two soluble dietary fibers, namely the polysaccharides agarose (70%; decisive for the gelling process) and agaropectin (30%). Due to a prebiotic action function attributed to agar-agar as a fermentable fiber material, negative intestinal bacteria are effectively reduced, thereby promoting the intestinal health of the dog.

At the same time, the fact is given that the liquid bound in the core medium by agar-agar, e.g. a bone broth rich in nutrients and minerals, after consumed transfer into the digestive apparatus (gastrointestinal tract), in predominant physical digestive correlation with the oral processing resp. the oral chewing mechanics of the dog (first gel break-up), as well as in particular the mechanical digestive or shearing forces counteracting in the gastrointestinal tract in the form of peristalsis in order to be able to expose the liquid (lightly) bound in the gel network under further continuous gel break-up, without recurring water-binding swelling in the intestine passage. Also, the nutrients, minerals and trace elements that may be contained therein (the bone broth) or supplements included in the liquid can be absorbed and absorbed. Agar-agar has been approved by both the Association of American Feed Control Officials (AAFCO) and the European Food Safety Authority (EFSA), with no maximum limit (ADI value, i.e. Acceptable Daily Intake) for food and feed and is considered safe for animal feed. Similarly, the appearance of a laxative digestive reaction in the face of a potentially excessive dosage of agar-agar can be denied the sachet in relation to the slightly implemented agar weight.

Furthermore, within the scope of the present invention, the use of already (commercially) ready-gelled products/substances is also conceivable, as well as of products/substances which sometimes have the secondary property of a liquid-donating characteristic.

In order to ensure that the central requirement criteria and intended functional, textural and quality-related properties of the sachet according to the invention can be qualitatively achieved and sustainably ensured in connection with the focused area of use with dogs and dog owners, the inclusion of a gelled liquid substance, or a gelled liquid-like product, was selected as the form of design most effectively adapted to the user and consumer group.

One requirement criterion is the tightness of the sachet with regard to a leakage-free closure of the membrane shell, so that no leakage of the gelled liquid product or core medium can occur, especially when force is exerted by the dog's ingestion process and product handling by the dog owner. This is ensured by enclosing the gelled liquid substance against the background of its homogeneous, non-flowing gel or hydrocolloid texture and resistance, as well as the plastic cohesive and cut- or bite-resistant textural property of the overall composition of the sachet.

The use of completely liquid to viscous-bound (liquid) substances would not result in the generation of a filled, stable, membrane-tight and bite-resistant sachet. Thus, among other things, there would be a decrease to resistance in a dog's intake acceptance and preference. In addition, due to the dog's pointed-sharp dental structure, which it uses for receptacle and consumption, the risk of leakage and loss of liquid, in the event of an exemplary rupture of the membrane, would be very high. The filling of a (soft) gel solid in the sense of a gelled liquid substance aims at a spatially dense and tightly filled sachet and thus enables a similarly closed and shaped sachet design. By providing physical stability of the sachet, a potentially existing effect of membrane elasticity and diffusion openness, and thus the risk of membrane slackness and drying out of the contents substance, can also be positively counteracted. Indeed, this would also involve direct interference with the preoral and oral receptacle, control, chewing and consumption processes.

A plastic robust sachet, which is achieved by filling a gelled liquid substance, offers a resistance and for the specific application process a sachet stability in product handling (transport) and in product administration by the dog owner. In addition, gelled liquid substances have a cooling property and also the advantage that they feel extremely refreshing in the mouth, especially on hot summer days (refreshment effect, which also contributes to the psychological perception of thirst quenching) and can be perceived under a high liquid association. The dog guides the sachet over the incisors and canines into its oral cavity and opens or activates the refreshing, moist gel discharge by controlled bite over the premolars.

Because of the plastic filling of the sachet intended by the gelled liquid substance, there is an effective receptacle, control, chewing and consumption process adapted to the dog. The intended bite strength, with regard to the rupture of the membrane shell in the mouth resulting from oral processing, is generated from the composition of the membrane or alginate shell and a brittle, soft-brittle and yet preferably easily cut-resistant substance that emerges after the bite. In this manner, for the first time, an edible liquid intake can be created for the dog. The texture-related, very different sensory system of the sachet awakens a holistically new receptacle and eating sensation for the dog consisting of bite firmness and yet existing softness as well as gel-like moisture in the course of a pleasant bursting effect.

The use of a gelled liquid substance also creates an intended material robustness, so that even if the sachet should accidentally fall to the base when administered by the dog owner in transition to the dog's ingestion behavior, it cannot immediately burst, tear or deform. Even in the event of a crack forming in the membrane shell, the content mass (hydrocolloid) lying therein, as already described above, is kept in shape in the gelled aggregate state and, unlike in the case of fluid to viscous liquid, there will be no loss of the core medium.

Since, as part of the dog's receptacle process, due to its natural behavioral pattern, there is often a receptacle of food components or edible reward instruments via the base, this can be easily covered by the sachet according to the invention. Even if the dog should bite open the sachet and ingest it in several cycles, this is preventively solved by the gelled content core, since the fracture behavior of the core medium is designed on the basis of the concentration of the gelling agent in such a way that it does not immediately disintegrate into individual, too small and/or too many gel fragments within the first mechanical contact such as that of oral chewing.

Furthermore, swallowing, as regularly occurs in the context of stationary liquid intake as well as in the current product solutions for mobile liquid supply of dogs, is excluded by the design form in the sense of casing of a gelled liquid substance by means of the low-friction membrane or alginate shell. The reason for swallowing during stationary liquid intake is incorrect channeling of the liquid absorbed very quickly by the dog (during acute thirst) into the trachea.

Due to the design composition of the sachet intended with the textural properties and the associated stability and bite strength, the dog associates mostly a familiar feeling of intake, as in the case of a conventional “treat or reward snack” and therefore takes the sachet primarily as a rewarding instrument (stimulus effectiveness) concerning the edible liquid. This revolutionizes mobile liquid intake even for a dog that is “lazy” about drinking, since there is a connection between the process of chewing or eating and a liquid supply (hydration) that is nevertheless intended by gastrointestinal release (resorption) and stress (absorption). Ultimately, the differentiating factor from the currently known, conventional and often high-fat and high-calorie reward snacks takes place primarily with regard to the basic need fulfillment of the mobile liquid supply of dogs, which is also promoted with the rewarding consumption.

The inclusion of a core medium in the sense of a non-flowing, cohesive, sometimes cuttable or cut-resistant gel solid (hydrocolloid) with an individual molecular network depending on the gelling agent used, in the membrane (preferably an alginate membrane) describes the design form which can optimally cover and serve the depth of need of a medium of a mobile liquid supply for primarily the dog but also the dog owner.

The designated exception of a core medium in the sense of a homogeneously prepared “fluid gel”, which can exhibit a divergent nature of a pasty-viscous and thus viscous gel, or (highly) viscous or viscous-viscous or viscous-elastic or viscous-solidly bound, thickened and/or flowable-gelled liquid substances can be filled and enclosed in the respective focused membrane shell. Even if with this alternative the physical parameter properties as well as functional properties for the dog's receptacle, control, chewing and eating ability may well not be achieved to exactly the same extent as with a non-flowable, (tightly) cohesive, sometimes cuttable or cut-resistant, (soft) gel solid as the preferred core medium, they may well still be converted to a satisfactory extent.

Preferably, the volume of the sachet comprises a range from approximately 2 cm³ to approximately 35 cm³, preferably from approximately 2.5 cm³ to approximately 30 cm³, further preferably from approximately 2.8 cm³ to approximately 25 cm³, further preferably from approximately 3 cm³ to approximately 20 cm³, and even more preferably from approximately 5 cm³ to approximately 15 cm³

Preferably, the sachet has a sausage-like, bag-like, oval-like, or ellipse-like shape, so that it can be picked up particularly well by a dog. However, spherical, cubic or triangular shapes and similar are also conceivable.

The shape-related design depends primarily on the receptacle, control, chewing and consumption process in connection with the anatomical dentition and tooth structure of a dog, which will be briefly explained below.

The canines of a dog are long and pointed. They are located behind the incisors at the front of the dog's mouth. With these, the dogs grasp and hold the respective food present as well as supplied and lock the object firmly in the mouth. The incisors, which are significantly smaller, are located between the canines. The dog uses the incisors to pick up smaller, more controllable pieces of food.

The cheek teeth, which are called premolars, are used by the dog to chew very hard food and to crush or break it up accordingly. The premolars are also very pointed and also covered with a hard enamel. They are located in the posterior area of the jaw.

Due to the plastic, firmly gelled, stably filled and cohesive, particularly sausage-like, bag-like, oval-like or ellipse-like shape of the sachet, the dog is provided with a large gripping surface in comparison to other geometric shapes such as the ball shape, geometric shapes, such as the spherical shape, the dog is provided with a relatively large gripping surface for the receptacle by the incisors and canines and, if necessary, on the basis of a long, flat surface of the underside of the sachet worked into the manufacturing process, can optimally pass it on in the mouth to the premolars and portion it for the consumption process.

Such a shape in combination with the consistently stable and bite-resistant design allows the dog to pick up, chew and eat the sachet in a controlled manner even during a dynamic walking process (firm locking by canine teeth). In addition, such a shape is adapted to the generally mostly elongated flat shape of a dog's mouth and thus more strongly accommodates the control and consumption mechanism.

But also for the dog owner as a giver, a sausage-like, pouch-like, oval-like or ellipse-like design of the sachet is more effective in terms of fit in the hand to handle and administer to the dog. By ensuring that the dog is accustomed to the receptacle, control, chewing and consumption process phases, the aspect that the dog actually pre-portions the sachet for consumption is also advanced, so that there is no risk of the sachet being swallowed whole. This fact could not necessarily be guaranteed to the same extent by a spherical shape, for example, due to the difficult receptacle and control ability in the mouth, as well as a significantly smaller grip and chewing surface. The intended shape also allows for a high association of dog owner and dog in terms of a reward tool.

In the following, further texture-relevant parameters of the sachet according to the invention are discussed.

Preferably, a maximum force for cutting through the sachet, which is formed approximately from the aforementioned substances, is in an area from about 5 N to about 25 N, preferably from about 6 N to about 15 N and further preferably in an area from about 7 to about 10 N and/or in an area from about 1 N to about 24 N, preferably from about 2 N to about 20 N, further preferably from about 3 N to about 15 N and still further preferably in an area from about 4 N to about 9 N. This strength parameter was measured by transversely shearing several samples with a Werner Brazler shear, wherein the maximum force required to cut through the samples was measured. This shows that the sachets have a deliberately lower bite strength than, for example, a Vienna sausage, for which the corresponding maximum force is approximately 38 N. The Vienna sausage is only included for comparison purposes with regard to the mechanical texture analysis in order to be able to represent the properties of the sachet according to the invention. The sample temperature here was +11° C. in each case.

Preferably, moreover, a total force to shear the sachet formed, for example, from the foregoing substances is in an area from approximately 0.05 J to approximately 0.25 J, preferably from approximately 0.1 J to approximately 0.2 J, and further preferably in an area from approximately 0.125 J to approximately 0.15 J and/or in an area from 0.01 J to 0.22 J. This strength was measured by transversely shearing a plurality of samples with, again, Werner Brazler shears, wherein the total force required to shear was measured. This means that sachets of this type have a significantly, deliberately, lower overall strength or a significantly reduced chewing effort than a Vienna sausage, for which the corresponding overall force is approximately 0.3 J.

Preferably, further, the peak force for a first compression of the sachet, formed for example from the foregoing substances, by 50% of its height is in an area from about 3 N to about 25 N, preferably from about 5 N to about 15 N, further preferably from about 9 N to about 12 N, still further preferably from about 10 N to about 11 N; and preferably, the peak force for a second compression of the sachet by 50% of its height is in an area from about 0.05 N to about 6 N, preferably from about 1 N to about 5 N, further preferably from about 2 N to about 4 N, and still further preferably from about 3.0 N to about 3.3 N. In this texture profile analysis (TPA) using an Instron 3365 texture meter (Instron Corp. Ltd, USA), several samples were cut into 1 cm high cylinders and these were placed on a plate. Subsequently, a plunger with a pressure plate larger than the specimen cylinder drives onto the sample from above and presses the specimen in by 50% of its height (5 mm). The plunger then drives back by 5 mm and then presses the sample in a second time by 5 mm before returning to the starting position. In this way, the elasticity can be determined particularly effectively for such samples. This shows that the force required to crush the sachet sample a second time is significantly smaller than for the first measurement. Again, just by way of comparison, the force required to crush the sample a second time for a wiener is still over 80% of the force from the first measurement; for the sachets, on the other hand, it is about 33% on average.

Preferably, the cohesiveness of the sachet formed, for example, from the foregoing substances is from about 0.01 to about 0.4, preferably from about 0.03 to about 0.3, more preferably from about 0.05 to about 0.2, and further preferably from about 0.06 to about 0.10. Cohesiveness indicates how well the product resists a second deformation in relation to its resistance under the first deformation. Here, the surface under a curve (J) during the second compression is divided by the surface under a curve (J) during the first compression. Cohesivity also shows the very plastic texture of the gelled liquid substance, which is held in shape by the surrounding membrane shell of the sachet. The combination of membrane shell and gelled liquid substance as core medium generates the intended textural property of a plastic, taut and robustly stable (including bite-resistant) and yet (gel-like) soft-purchasing design form.

A cohesivity value of 1 would mean approximately that the sample behaves 100% elastically and thus the required energy remains the same when it is loaded again. For comparison, a wiener has approximately a cohesivity value of 0.5.

It should be noted that the slight elastic behavior of the sachet refers to the overall composition of membrane and gelled liquid substance. This property is intended and aimed for in the sachet according to the invention, since this achieves a consistently stable and consistently plastic shaped sachet both for the functional property of optimal product handling by the dog owner and a firmly centered, controllable sachet in the dog's intake process up to the chewing and consumption process.

Elastic behavior, on the other hand, would result in excessive mobility of the sachet, whereupon on the one hand, in relation to the enclosed gel solid, there is a risk of too little gel fracture behavior in view of too high a rate of elongation at break, and on the other hand, in connection with the enclosing membrane, there is a risk of too much expansion with the texture-related effect of membrane slackness. For example, both an alginate shell and a hydrocolloid made from agar-agar, considered individually, have elastic (in the case of agar gel, depending on the amount of agar weighed; for sachet, a less elastic, i.e., majority brittle agar gel texture is preferably concentrated even independently of membrane shell) and fracture-mechanical structural behavior, but when these two elements are combined, they transform into the physical nature already explained in the above points. The low elongation at break or elasticity (based on a low agar content such as approximately 0.7 to 1.1% by weight) of the soft-brittle gel body enclosed in the sachet according to the invention therefore also accommodates easier mechanical deformation of the gel, with gel cohesion nevertheless present during chewing shear and the subsequent swallowing shear.

Preferably, the gumminess of the sachet, which is formed, for example, from one of the aforementioned substances, is from about 0.03 N to about 11.0 N, preferably from about 0.3 N to about 10.0 N, further preferably from about 0.5 N to about 3.0 N, and further preferably from about 0.7 N to about 1.0 N. Gumminess is usually measured only for semi-solid products and can be used as a parameter describing the energy required to comminute a sample during mastication. Gumminess is calculated as the product of hardness times cohesiveness. The values for such a sachet again show a brittle and less elastic behavior, since only a very small amount of force is required to compress the sample by 50% of its height. The highly pronounced brittleness is sometimes an essential mechanical texture parameter in view of a dynamic gel fracture behavior highly dependent with the gastrointestinal physical digestive effects for a (faster) peristaltic fluid leakage.

The above values for maximum force, total force, peak force, cohesiveness and gumminess derived from the texture analytical studies illustrate that the corresponding sachets preferably have a cut-resistant but gel-like, soft structure that is very easy to chew, particularly for dogs. If one were to compare the sachet with a wiener, the bite strength would be approximately 20%. Very low elasticity is preferred, which can be close to zero, whereas a fully elastic sample would have a value of 1.

It follows from this that the gelled liquid substance, even in low concentration spheres in connection with a low water-binding and water-retaining power, preferably has a very plastic as well as brittle and yet stably cohesive texture in the interior, which is held in its shape by the membrane surrounding it, so that the (soft) gel solid cannot escape. After biting and orally breaking open the membrane shell, the emerging core medium can be very easily chewed and already pre-broken into smaller gel pieces at a certain ratio for the upcoming digestion process.

The membrane, which is adapted to the homogeneously gelled core of the contents, and which is wrapped around or connected to it, gives the product an application- and process-related as well as (fracture-)mechanical and motor stability and strength in relation to the field of application of edible, mobile liquid supply and receptacle of dogs in particular, whereby it is also easily tradable and process-stable in further stress situations (packaging, thermal pressure, transport, touching, pressing).

It should be pointed out again at this location that the (conventional) Vienna sausage was used in the present case purely in the sense of a measurement scale used for orientation purposes concerning the interpretation of the texture properties represented for the sachet, since the sachet according to the invention embodies a completely novel product structure. The wiener otherwise serves a completely different field of application and has a clearly differentiated result with regard to the physical parameter properties compared to the sachet according to the invention.

Preferably, the sachet further comprises a length of from approximately 2 cm to approximately 10 cm, preferably from 2.5 cm to 9 cm, more preferably from 2.8 cm to 8 cm, more preferably from 3 cm to 7 cm, and even more preferably from 4 cm to 6 cm, and preferably a diameter of approximately 1.0 cm to 3.0 cm, preferably from approximately 1.2 cm to approximately 2.5 cm, more preferably from approximately 1.5 cm to approximately 2.3 cm, further preferably from approximately 1.6 cm to approximately 2.2 cm and still further preferably from approximately 1.7 cm to approximately 1.9 cm. The size of the sachet depends primarily on the size of the dog. The dimensions for the length are to be understood minus any twist-off points connected on both sides (e.g. in the case of a coextrusion system with twist-off function) of a sachet.

An example of a particularly preferred embodiment in the image of a first standardized variant of the sachet has a volume of approximately 10 cm³. In the case of a likewise particularly preferred sausage-like, bag-like, oval-like or ellipse-like shaping of the sachet, a diameter of approximately 18 mm and a length of approximately 50 mm (or 55 mm from twist-off point to twist-off point) is particularly preferred. The portion weight of the sachet, i.e. the alginate membrane (e.g. 0.2 mm envelope thickness) and a liquid substance gelled with agar-agar (e.g. 0.9 wt. % agar weight) (e.g. minimum volume portion of 10 ml liquid), is approximately 10.7 g (arithmetic mean). In this embodiment example, the weight of the alginate membrane is approximately 0.6 g (taking into account the moisture content bound in the alginate shell). Thus, the gelled liquid enclosed therein is at a content weight of approximately 10.1 g, as well as minus the 0.9 wt % agar concentration of approximately 10 g of purely fluid liquid available to the canine organism. Consequently, the proportion by weight of the liquid in this example is approximately at least 90% (i.e. of the total weight of the sachet). Smaller proportions by weight of the liquid of at least approximately 70% or larger proportions by weight of the liquid of at least approximately 95% are also conceivable for a sachet according to the invention.

Preferably, these homogeneously prepared, pasty-viscous “fluid gels”, as well as the (highly) viscous or (highly) viscous or pasty-viscous or viscous-elastic or viscous-solidly bound, thickened and/or flowable-gelled fluid substances have a viscosity of more than 70,000 mPas, preferably from approximately 75,000 mPas to approximately 250,000 mPas and particularly preferably from approximately 90,000 mPas to approximately 200,000 mPas. As with the viscosity values given here, viscosity is predominantly measured at room temperature, such as approximately 20° C. Due to the appropriate viscosity level of the designated alternative of the core medium, it can be ensured that the contents do not become (too) liquid and leak (quickly) when bitten.

The sachets according to the invention can be produced approximately by means of a coextrusion system with leak-free twist-off function. Another possibility is to completely enclose or encapsulate by means of a suitable encapsulator, wherein no twist-off points or seams are then created. In principle, however, all types of mechanical, mechanical-technological or manual process methods that can realize a casing and sealing (edible membrane) of a core medium (gelled liquid substance) are possible.

In the table below, for the purpose of clarity, the experience-based, approximate daily food and fluid requirements for dogs weighing 5, 10 and 20 kilograms are given:

| | 5 KG | | | | 10 KG | | | | 20 KG | | | |
|---|---|---|---|---|---|---|---|---|---|---|---|---|
| | Normal | | Active | | Normal | | Active | | Normal | | Active | |
| Activity/temp. | <20° | C. | <20° | C. | <20° | C. | <20° | C. | <20° | C. | <20° | C. |
| [° C.] | >20° | C. | >20° | C. | >20° | C. | >20° | C. | >20° | C. | >20° | C. |
| Dry | 200-250 | ml | to 500 | ml | 400-500 | ml | to 1000 | ml | 800-1000 | ml | to 2000 | ml |
| Food | 250-500 | ml | to 750 | ml | 500-1000 | ml | to 1500 | ml | 1000-2000 | ml | to 3000 | ml |
| Wet | 25-50 | ml | to 250 | ml | 50-100 | ml | to 500 | ml | 100-200 | ml | to 1000 | ml |
| Food | 100-250 | ml | to 500 | ml | 200-500 | ml | to 1000 | ml | 400-1000 | ml | to 2000 | ml |

In the table below, again, the experience-based, approximate daily food and liquid requirements for dogs weighing 30 and 40 kilograms are given:

| | 30 kg | | 40 kg | |
|---|---|---|---|---|
| | Normal | Active | Normal | Active |
| Activity/temp. | <20° C. | <20° C. | <20° C. | <20° C. |
| [° C.] | >20° C. | >20° C. | >20° C. | >20° C. |
| Dry | 1200-1500 ml | to 3000 ml | 1600-2000 ml | to 4000 ml |
| Food | 1500-3000 ml | to 4500 ml | 2000-4000 ml | to 6000 ml |
| Wet | 150-300 ml | to 1500 ml | 200-400 ml | to 2000 ml |
| Food | 600-1500 ml | to 3000 ml | 800-2000 ml | to 4000 ml |

The pre-dosed sachets in accordance with the present invention are preferably designed with regard to the amount of gastrointestinal absorbable and absorbable liquid from the gelled content core or hydrocolloid (core medium) in such a manner that the dog is supplied with not too little but also not too much liquid per portion unit administered to him, and that the number and frequency rate of sachets given by the dog owner can be individually and self-determinedly adapted to the needs of the respective dog and any external influencing factors (environmental temperature, activity level, etc.) can be adapted. In comparison with a conventional reward snack, the sachet for the mobile liquid supply of dogs has a high content volume and thus also a high benefit curve.

In the following, reasons and consequences of insufficient liquid intake in dogs will be summarized again. The basis for this study refers to the behavioral abnormalities of general liquid intake in dogs.

One reason for insufficient liquid intake is first of all the general drinking inertia of dogs. Also to be mentioned is a lack of awareness on the part of the dog and dog owner with regard to regular, sufficient liquid intake or liquid supply as well as control, especially in the mobile interfaces of a dog's everyday life. In connection with this, there is also insufficient information regarding potential health and behavioral (long-term) consequences for the dog, which become apparent on the basis of insufficient liquid intake or liquid deficiency.

Furthermore, high activity-related stress requirements and an associated high demand for exercise lead to a reduction of hydration (fluid balance) in the organism and consequently cause the decrease of vitality and generation of sluggishness in the dog's behavior. The tastelessness and odorlessness of tap water and the resulting lack of incentive to drink should also be mentioned, as well as the lime content in tap water, which often results in intolerance and abstinence from drinking on the part of the dog.

Furthermore, behaviorally challenged dogs as well as older dogs are very difficult to re-educate, especially with regard to a conscious, rewarding, pleasurable and motivating liquid intake that has not been available so far. From this it follows that the dog drinks approximately in the mobile interface “walk” from contaminated puddles or ponds or takes no liquid at all. External (behavioral) disturbances of drinking behavior, such as a mirror-like reflection or noise generation in the case of stationary water bowls coated with aluminum, for example, or a repulsive plastic odor in the case of mobile transport containers, are also reasons for abstinence from drinking. A lack of reward and mobility association, against the background that according to the current status quo of available product solutions, mobile liquid intake and supply, both from the dog's point of view and from the dog owner's point of view, does not represent a reward and therefore not a mobile tool with which the dog owner can animate and remind the dog to regular liquid intake, is also an aspect that should not be underestimated.

With regard to the mobile solutions available to date for the liquid supply of dogs, the dog will have a similar behavioral problem as with the stationary liquid supply, in the sense that he does not perceive it as a rewarding, differentiated instrument. The invention referred to herein generates for the first time the product genus of an “edible (mobile) liquid intake” for dogs.

However, the objective of the “sachet” according to the invention is not to cover or replace the stationary liquid supply of the dog, but to provide an effective supplementary product for covering the necessary amount of fluid to be taken in by a dog per day and to make it possible for the first time to integrate it in the mobile everyday areas as a (mobile) source of hydration for dogs and dog owners on a multiday basis. In addition, the focus is on potentially encouraging the dog to intensify its stationary liquid intake through the composition of the contents of the sachet (e.g. saline calcium chloride content in cross-linked alginate membrane and approximately a salt content adapted to the dog's organism with regard to an exemplary design form with a bone broth), taking into account the frequency rate and number of sachets consumed by the dog per day.

Finally, the parameter complexity must be taken into account with regard to individual differences in the daily fluid requirement and, among other things, situational changes in a dog's fluid requirement (e.g. if the activity level and/or the environmental temperature increases, the fluid requirement also increases simultaneously). These include, above all, parameters such as size, body weight, temperature (season), age, exercise requirement (activity in the mobile interface), a loss of fluid due to laxative impairments or clinical pictures (diarrhea, kidney disease, fever, diabetes mellitus, etc.) and the amount of fluid or moisture contained in the respective type of food (wet food, dry food or BARF).) and the liquid or moisture content in the respective type of food (wet food, dry food or BARF) or the manually added amount of liquid, such as in the case of dry food, and the liquid-depriving components in the type of food, if any, as well as the daily feeding frequency. Further, there is the fact that dogs do not (can not) reach the minimum requirement of liquid throughout the dog's daily life, and the hydration needs that arise in the mobile daily interfaces.

A regular, sufficient and controllable liquid supply, consisting of a direct correlation of mobile and stationary hydration, is of extraordinary importance for the dog. The basic need for sufficient, regular liquid intake is essential for the vitality (well-being) and health of dogs, as water or liquid combines multiple functional properties. It is of relevant importance for the major part of all processes in the body, which in dogs consists of 70 to 80% water. Liquid supply is also essential for the dissolution of feed components in the digestive tract, for the transport of important nutrients from the intestinal tract via the bloodstream to the fabrics and, in addition, it is responsible for cell metabolism and for the excretion of urinary substances via the kidneys.

In addition, the liquid supply regulates the body temperature and thus serves to quench a panting behavior occurring in the course of a high physical stress or a high temperature effect on the dog's organism with the aim of quenching thirst and stabilizing the circulation. Dogs should consume liquids approximately every 30 minutes, particularly on climatically hot days. This need is even more urgent in the context of mobile interfaces, such as long walks. Here there is an acute feeling of thirst, which can be effectively or preventively quenched or prevented with the sachet according to the invention.

The positive effects of an adequate liquid supply of dogs that can be achieved in this way comprise a constant hydration, agility, vitality, strengthened physiological as well as energetic health, digestive support, strengthening of the circulation as well as a general improvement of the processes taking place in the canine organism.

The sachet according to the invention is also suitable as a transport medium (active ingredient inclusion and active ingredient dissolution) for particularly liquid or powdery veterinary products. In addition, tablets can also be pressed into the gelled core medium, if necessary, to make administration easier for the dog owner.

The invention of “sachets” makes mobile liquid intake a hydrating, thirst-quenching, refreshing, (pre-)orally controllable, rewarding and always accessible experience for dogs in mobile interfaces. The sachet enables the liquid supply of dogs by an easy, handy (mobile) and flexible applicable, controllable, in a single medium supply instrument for the dog owner.

### BRIEF DESCRIPTION OF THE DRAWINGS

Further advantageous embodiments of the invention emerge from the following description of exemplary embodiments of the invention with the aid of the schematic drawing. In particular, the sachet according to the invention is described in more detail below with reference to the accompanying drawings by means of exemplary embodiments.

FIG. 1 shows a cross-sectional view through the sachet according to the invention.

FIG. 2 shows a side view of the sachet according to the invention.

### DETAILED DESCRIPTION

Certain expressions are used in the following description, where appropriate, for convenience and are not intended to be restrictive. The words “right,” “left,” “bottom” and “top” denote directions in the drawing to which reference is made. The terms “inward,” “outward,” “below,” “above,” “left,” “right” or similar are used to describe the arrangement of designated parts relative to one another, the movement of designated parts relative to one another and the directions toward or away from the geometric center of the invention and designated parts thereof as shown in the drawings. This spatial relative information also comprises different positions and orientations from those shown in the drawings. For example, if a part shown in the drawings is reversed, elements or features that are described as “below” are then “above.” The terminology comprises the words expressly mentioned above, their derivations and words with similar meanings.

In order to avoid repetitions in the drawings and the associated description of the different aspects and embodiments, certain features are to be understood as common for different aspects and embodiments. The omission of an aspect in the description or a drawing does not suggest that this aspect is missing in the associated embodiment. Rather, such omissions are made for the sake of clarity and to avoid repetition. In this context, the following stipulation applies to the entire further description: If reference numerals are contained in a figure for the purpose of graphic unambiguity but are not mentioned in the directly associated descriptive text, reference is made to their explanation in preceding figure descriptions. If reference signs are also mentioned in the text of the description relating directly to a figure that are not included in the corresponding figure, reference is made to the preceding and following figures. Similar reference signs in two or more drawings represent similar or identical elements.

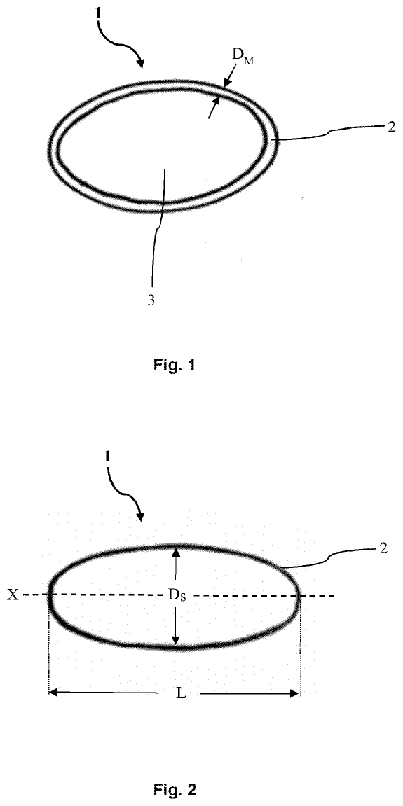

In FIG. 1, a sachet 1 according to the invention with a membrane 2 (or casing) surrounding the gelled liquid substance 3 (or core medium) is illustrated in cross-section. The membrane 2 has a thickness D_{M}. The membrane 2 can be designed as a single-layer, double-layer or multilayer membrane.

In FIG. 2, the sachet 1 according to the invention is illustrated in accordance with FIG. 1 in side view. The sachet 1 has a length L along the longitudinal axis X and, perpendicular and centered thereto, a diameter D_{S}. The section for the view in accordance with FIG. 1 extends approximately along the double arrow for diameter D_{S}. In this exemplary embodiment, the sachet 1 has a sausage-like, bag-like, oval-like or ellipse-like shape. In this exemplary embodiment, the sachet is integrally encapsulated and to that extent has no twist-off points at its longitudinal ends.

The present disclosure also includes embodiments having any combination of features that are mentioned or shown above or below with respect to various embodiments. It also includes individual features in the figures, even if they are shown there in connection with other features and/or are not mentioned above or below. Alternatives of embodiments described in the figures and the description and individual alternatives of their features can also be excluded from the subject matter of the invention or from the disclosed subject matter. The disclosure includes embodiments comprising exclusively the features described in the claims or in the exemplary embodiments and those comprising additional features.

Furthermore, the expression “comprise” and derivations thereof do not exclude other elements or steps. Likewise, the indefinite article “a” or “an” and derivations thereof do not exclude a plurality. The functions of several features listed in the claims can be performed by one unit or one step. The terms “substantially,” “approximately,” “about” and the like, when used in conjunction with a property or value, in particular also define precisely that property or that value. The terms “approximately” and “about” in the context of a given numerical value or range may refer to a value or area, respectively, that is within 20%, within 10%, within 5%, or within 2% of the given value or range, respectively.

### LIST OF REFERENCE SIGNS

1 sachet
2 membrane (casing)
3 gelled liquid substance (core medium)
L length of sachet
D_{M} thickness of membrane
D_{S} diameter of sachet
X longitudinal axis of sachet

### Further Embodiments Comprise:

Embodiment 1: Sachet (1) for a mobile liquid supply of dogs in particular, with a casing (2) as well as a core medium (3) enclosed by the casing, wherein the casing (2) is formed of an edible membrane, and wherein the core medium (3) is formed of a gelled liquid substance.

Embodiment 2: Sachet (1) in accordance with embodiment 1, wherein the edible membrane comprises a polymer, preferably alginate.

Embodiment 3: Sachet (1) in accordance with embodiment 2, wherein the alginate is crosslinked with a calcium chloride solution.

Embodiment 4: Sachet (1) in accordance with embodiment 2 or 3, wherein the alginate is formed from an alginate paste containing sodium alginate.

Embodiment 5: Sachet (1) in accordance with any of the preceding embodiments, wherein the edible membrane has a thickness (D_{M}) of from approximately 0.05 mm to approximately 5 mm, preferably from approximately 0.1 mm to approximately 2 mm, more preferably from 0.15 mm to 1.5 mm, and even more preferably from approximately 0.2 mm to approximately 1 mm.

Embodiment 6: Sachet (1) in accordance with any of the preceding embodiments, wherein the gelled liquid substance comprises in particular soups, broths or smoothies on animal, biological vegetable, vegetarian or vegan basis, or drinking water, hydrogels, yogurt drinks, shakes, juices, teas or liquid supplements.

Embodiment 7: Sachet (1) in accordance with any of the preceding embodiments, wherein the gelled liquid substance is gelled by means of gelling agents such as in particular agar-agar, gelatin, alginate, carrageenan, pectin or tragacanth and/or by means of binding and thickening agents such as in particular locust bean gum, guar gum, arrowroot gum, psyllium husks, corn starch, potato starch, xanthan gum, gum arabic, tara gum or gellan.

Embodiment 8: Sachet (1) in accordance with any of the preceding embodiments, wherein the volume of the sachet (1) comprises a range from approximately 2 cm³ to approximately 35 cm³, preferably from approximately 2.5 cm³ to approximately 30 cm³, further preferably from approximately 2.8 cm³ to approximately 25 cm³, further preferably from approximately 3 cm³ to approximately 20 cm³, and still further preferably from approximately 5 cm³ to approximately 15 cm³.

Embodiment 9: Sachet (1) in accordance with any of the preceding embodiments, wherein a maximum force to cut the sachet (1) is in a range from approximately 5 N to approximately 25 N, preferably from approximately 6 N to approximately 15 N, and further preferably in a range from approximately 7 to approximately 10 N, and/or in a range from approximately 1 N to approximately 24 N, preferably from approximately 2 N to approximately 20 N, further preferably from approximately 3 N to approximately 15 N, and still further preferably in a range from approximately 4 N to approximately 9 N.

Embodiment 10: Sachet (1) in accordance with any of the preceding embodiments, wherein a total force to cut the sachet (1) is in a range from approximately 0.05 J to approximately 0.25 J, preferably from approximately 0.1 J to approximately 0.2 J, and further preferably in a range from approximately 0.125 J to approximately 0.15 J, and/or in a range from 0.01 J to 0.22 J.

Embodiment 11: Sachet (1) in accordance with any of the preceding embodiments, wherein the peak force for a first compression of the sachet (1) by 50% of its height is from approximately 3 N to approximately 25 N, preferably from approximately 5 N to approximately 15 N, more preferably from approximately 9 N to approximately 12 N, even more preferably from approximately 10 N to approximately 11 N, and that preferably the peak force for a second compression of the sachet (1) by 50% of its height is from approximately 0.05 N to approximately 6 N, preferably from approximately 1 N to approximately 5 N, more preferably from approximately 2 N to approximately 4 N, and even more preferably from approximately 3.0 N to approximately 3.3 N.

Embodiment 12: Sachet (1) in accordance with any of the preceding embodiments, wherein the cohesiveness of the sachet (1) is from approximately 0.01 to approximately 0.4, preferably from approximately 0.03 to approximately 0.3, more preferably from approximately 0.05 to approximately 0.2, and even more preferably from approximately 0.06 to approximately 0.10.

Embodiment 13: Sachet (1) in accordance with any of the preceding embodiments, wherein rubberiness of the sachet (1) is from approximately 0.03 N to approximately 11.0 N, preferably from approximately 0.3 N to approximately 10.0 N, further preferably from approximately 0.5 N to approximately 3.0 N, and still further preferably from approximately 0.7 N to approximately 1.0 N.

Embodiment 14: Sachet (1) in accordance with any of the preceding embodiments, wherein it has a length (L) of from approximately 2 cm to approximately 10 cm, preferably from 2.5 cm to 9 cm, more preferably from 2.8 cm to 8 cm, further preferably from 3 cm to 7 cm, and still further preferably from 4 cm to 6 cm, and preferably has a diameter (D_{S}) of approximately 1.0 cm to 3.0 cm, preferably from approximately 1.2 cm to approximately 2.5 cm, more preferably from approximately 1.5 cm to approximately 2.3 cm, more preferably from approximately 1.6 cm to approximately 2.2 cm, and still more preferably from approximately 1.7 cm to approximately 1.9 cm.

Embodiment 15: Sachet (1) in accordance with any of embodiments 1 to 8 and 14, wherein the gelled liquid substance has a viscosity of greater than 70,000 mPas, preferably from approximately 75,000 mPas to approximately 250,000 mPas, more preferably from approximately 90,000 to approximately 200,000 mPas.

Embodiment 16: Sachet (1) in accordance with any of the preceding embodiments, wherein the proportion by weight of the liquid to the total weight of the sachet is at least approximately 70%, preferably at least approximately 90%, and further preferably at least approximately 95%.

1. A sachet for a mobile liquid supply of dogs in particular, comprising:
a casing; and
a core medium enclosed by said casing,
wherein the casing is formed of an edible membrane,
wherein the core medium is formed from a gelled liquid substance,
wherein a maximum force for cutting the sachet is in a range from approximately 1 N to approximately 24 N, and
wherein a total force to cut the sachet is in a range from approximately 0.01 J to approximately 0.22 J.

2. The sachet according to claim 1, wherein the edible membrane comprises a polymer, preferably alginate.

3. The sachet according to claim 2, wherein the alginate is crosslinked with a calcium chloride solution.

4. The sachet according to claim 2, wherein the alginate is formed from an alginate paste containing sodium alginate.

5. The sachet according to claim 1, wherein the edible membrane has a thickness of from approximately 0.05 mm to approximately 5 mm, preferably from approximately 0.1 mm to approximately 2 mm, and more preferably from approximately 0.2 mm to approximately 1 mm.

6. The sachet according to claim 1, wherein the gelled liquid substance comprises soups, broths or smoothies on animal, biological vegetable, vegetarian or vegan basis, or drinking water, hydrogels, yogurt drinks, shakes, juices, teas or liquid supplements.

7. The sachet according to claim 1, wherein the gelled liquid substance is gelled by means of a gelling agent and/or by means of a binding and thickening agent agents.

8. The sachet according to claim 1, wherein a volume of the sachet comprises a range from approximately 2 cm³ to approximately 35 cm³, preferably from approximately 3 cm³ to approximately 20 cm³, and further preferably from approximately 5 cm³ to approximately 15 cm³.

9. The sachet according to claim 1, wherein the maximum force for cutting the sachet is in a range from approximately 6 N to approximately 15 N, and further preferably in a range from approximately 7 to approximately 10 N.

10. The sachet according to claim 1, wherein the total force to cut the sachet is in a range from approximately 0.1 J to approximately 0.2 J, and further preferably in a range from approximately 0.125 J to approximately 0.15 J.

11. The sachet according to claim 1, wherein a peak force for a first compression of the sachet by 50% of its height is from approximately 5 N to approximately 15 N, preferably from approximately 9 N to approximately 12 N, more preferably from approximately 10 N to approximately 11 N, and that preferably the peak force for a second compression of the sachet by 50% of its height is from approximately 1 N to approximately 5 N, preferably from approximately 2 N to approximately 4 N, and more preferably from approximately 3.0 N to approximately 3.3 N.

12. The sachet according to claim 1, wherein a cohesiveness of the sachet is from approximately 0.03 to approximately 0.3, preferably from approximately 0.05 to approximately 0.2, and further preferably from approximately 0.06 to approximately 0.10.

13. The sachet according to claim 1, wherein a rubberiness of the sachet is from approximately 0.3 N to approximately 10.0 N, preferably from approximately 0.5 N to approximately 3.0 N, and further preferably from approximately 0.7 N to approximately 1.0 N.

14. The sachet according to claim 1, wherein the sachet has a length of from approximately 2 cm to approximately 10 cm, preferably from 3 cm to 7 cm and further preferably from 4 to 6 cm, and preferably has a diameter of from approximately 1.0 cm to 3.0 cm, preferably from approximately 1.5 cm to approximately 2.3 cm and further preferably from approximately 1.7 cm to approximately 1.9 cm.

15. The sachet according to claim 1, wherein a proportion by weight of the liquid to a total weight of the sachet is at least approximately 70%, preferably at least approximately 90%, and further preferably at least approximately 95%.

16. The sachet according to claim 7, wherein the gelling agent is selected from a group consisting of agar-agar, gelatin, alginate, carrageenan, pectin and tragacanth.

17. The sachet according to claim 7, wherein the binding and thickening agent is selected from a group consisting of locust bean gum, guar gum, arrowroot gum, psyllium husks, corn starch, potato starch, xanthan gum, gum arabic, tara gum and gellan.
